(19) United States
(12) Patent Application Publication
(10) Pub. No.: US 2024/0318584 A1
(43) Pub. Date: Sep. 26, 2024

(54) METHOD FOR HEATING AN EXHAUST GAS SYSTEM

(71) Applicant: Robert Bosch GmbH, Stuttgart (DE)

(72) Inventors: Michael Bachner, Stuttgart (DE); Marcel Alexander Schneck, Besigheim (DE); Vandana Hegde, Korntal-Muenchingen (DE)

(21) Appl. No.: 18/609,118

(22) Filed: Mar. 19, 2024

(30) Foreign Application Priority Data
Mar. 20, 2023 (DE) 10 2023 202 446.2

(51) Int. Cl. F01N 3/20; F01N 11/00

(52) U.S. Cl. CPC F01N 3/2013; F01N 11/005; F01N 2560/06

(57) ABSTRACT

A method for controlling heat transport within an exhaust gas system downstream of an internal combustion engine, wherein the exhaust gas system comprises at least one electrical heating device, at least one exhaust gas purification component, and at least one fluid transport device, wherein the method comprises, in an operating phase in which the internal combustion engine is not operated, determining at least one current temperature in the exhaust gas system, performing a comparison of the at least one determined current temperature or a temperature derived therefrom with a target temperature, and controlling the electrical heating device and/or the fluid transport device as a function of the result of the comparison. Furthermore, a computing unit and a computer program for carrying out such a method are proposed.

### BACKGROUND

The present invention relates to a method for heating an exhaust gas system downstream of an internal combustion engine as well as to a computing unit and a computer program for carrying it out.

Three-way catalyst converters (TWC), which enable the conversion of the relevant gaseous pollutants NOx, HC, and CO into harmless products such as N₂, H₂O, and CO₂, can be used to achieve legally prescribed emission limits. In order for these catalytic reactions to proceed as intended, the temperatures in the catalyst converter generally must exceed the so-called light-off temperature of typically 300-400° C. As soon as this temperature is reached or exceeded, the catalyst converts the relevant pollutants almost completely (so-called catalyst converter window).

In order to achieve this state as quickly as possible, what are referred to as internal engine catalyst converter heat uptakes can be applied. In so doing, the efficiency of the gasoline engine is lowered as a result of late ignition angles, and the exhaust gas temperature and enthalpy input into the catalyst converter are thus increased. Using adapted injection strategies (e.g., multiple injections), combustion stability can simultaneously be ensured.

The constant tightening of existing exhaust gas limits and regulation of additional pollutant components (e.g., ammonia, NH₃) leads to increasing complexity of exhaust gas after-treatment systems, which usually consist of several catalyst converters connected in series. For space reasons, catalyst converters are also used in the underbody in addition to the catalyst converters located close to the engine.

In addition to the aforementioned internal catalyst converter heating measures, external catalyst converter heating measures can also be used, for example by means of electrically heated catalyst converters or exhaust gas burners. Such external heating measures are described, for example, in DE 41 32 814 A1 and DE 195 04 208 A1. They are particularly suitable for quickly heating components of the exhaust gas system that are installed away from the engine to the required operating temperature, as the internal engine heating measures do not take effect at these points, or only after a long time.

In the past, it was often sufficient to initially heat the catalyst converters close to the engine above the light-off temperature during a cold start and, if necessary, to reheat them moderately if they cooled down considerably. To control the heating measures, a target temperature can be specified at a specific position in the exhaust gas system. Depending on the load, a temporary increase in exhaust gas temperature may occur for particulate filter regeneration.

For the most effective exhaust gas after-treatment of the various emission components, it will be necessary in future to operate the various catalyst converters in the exhaust gas tract (including underbody catalyst converters) in the optimum temperature range in each case. The required heating measures are usually associated with a fuel consumption disadvantage and should therefore be used and coordinated as optimally and efficiently as possible. For reasons of efficiency, heat should be released as far as possible at the position where the temperature is currently required.

### SUMMARY

According to the invention, a method for heating an exhaust gas system downstream of an internal combustion engine as well as a computing unit and a computer program for carrying it out are proposed. In particular, the invention is suitable for use in vehicles, but is not limited to such use. Any references to vehicle components are therefore, unless expressly stated otherwise, to be regarded merely as illustrative examples and not as limiting the scope of the invention.

A method according to the invention for controlling a heat transport within an exhaust gas system downstream of an internal combustion engine (e.g., gasoline or diesel engine or other internal combustion engine such as gas or H₂ burner), wherein the exhaust gas system comprises at least one electrical heating device, at least one exhaust gas purification component, and at least one fluid transport device, comprises, in an operating phase in which the internal combustion engine is not operated, determining at least one current temperature in the exhaust gas system, carrying out a comparison of the at least one determined current temperature or a temperature derived therefrom with a target temperature and controlling the electrical heating device and/or the fluid transport device as a function of the result of the comparison. This allows heat to be distributed within the exhaust gas system and/or introduced into the exhaust gas system as required in order to maintain the target temperature without the need for motorized heating measures. In particular, the load on an electrical energy system is limited to a minimum required level.

Electrical heating devices, hereinafter also referred to as heating disks without limitation to the specific design of the heating device, which are installed in the exhaust gas system, make it possible to introduce heat into the exhaust gas system by means of electrical energy from the vehicle electrical system, independently of the engine conditions and in particular already when the engine is (still) stopped, which is transported into the components of the exhaust gas system arranged downstream of the heating disk(s) by means of the engine exhaust gas mass flow or using externally supplied transport air. However, the electrical energy consumption leads to a corresponding load on the vehicle's electrical system and battery. The method according to the invention makes it possible to minimize energy consumption by requesting and providing the required amount of heat or heating output as precisely as possible. In the context of the invention, for example, heat is transferred from components that are more than sufficiently warm to components that are too cool (i.e., below the target temperature) and only heated electrically when internal redistribution of heat is no longer sufficient to reach or maintain the target temperature.

In particular, the fluid transport device, for example a secondary air pump, is set up to move fluid for heat transport both in a flow direction from the internal combustion engine in the direction of the exhaust gas system and in the opposite direction, i.e., from the exhaust gas system in the direction of the internal combustion engine. In the case of a rotor fan as a fluid transport device, the direction of rotation can be reversed or the angle of attack of the rotor can be inverted. A fluid transport device with valve-controlled switching of the fluid transport path (e.g., supply of secondary air upstream or downstream of a catalyst converter) can also be used to control the heat transport direction.

In particular, the current temperature in the exhaust gas system is determined on the basis of a temperature model of the exhaust gas system.

The use of a model-based (pre-)control system makes it possible to directly calculate the required heating output or the required heat transfer on the basis of physical parameters, for example temperature upstream and/or in the heating disk, temperature of one or more exhaust gas purification components, mass of the catalyst converter to be heated, heat capacities and the like, and to take into account all physically relevant influencing parameters. An optional additional (e.g., PID) controller only has to regulate disturbance variables. Furthermore, a maximum permissible temperature can be defined and compliance with this can be monitored using the temperature model. This protects important components of the exhaust gas system (e.g., heating disk, catalyst converter, particulate filter, etc.) from damaging overheating.

In operating phases in which the internal combustion engine is not in operation, for example in purely electrically driven phases of a journey with a combustion-electric hybrid vehicle, the exhaust gas system generally does not cool down evenly, but will cool down faster or more strongly at certain positions than at other positions, depending on the installation situation, in particular due to the inflow of ambient air. In particular, the cooling behavior here differs from “normal” overrun operation of the internal combustion engine, in which the exhaust gas system cools down from the front to the rear, as cold air is pumped through the exhaust gas system by the internal combustion engine. Therefore, compared to the solution presented here, conventional methods are less flexible with regard to various application scenarios for the thermal management of exhaust gas systems of internal combustion engines.

With the present invention, heat can be transported precisely from areas that cool down less to areas that are more affected by cooling, in order to minimize the load on the electrical system caused by the electrical heating device, without having to sacrifice the convertibility of the catalyst converter.

In some embodiments, the method further comprises determining a temperature distribution within the exhaust gas system based on the at least one current temperature, wherein the temperature distribution describes respective local temperatures for at least two spaced apart positions in the exhaust gas system, wherein each of the local temperatures is used as a temperature derived from the at least one current temperature for the comparison.

The fluid transport device can preferably be controlled in such a way that the fluid transported by it transports heat from a first of the at least two positions to a second of the at least two positions if the result of the comparison is that the local temperature at the second position falls below the target temperature and at the same time the local temperature at the first position exceeds the target temperature. This allows excess heat from the exhaust gas system to be used to keep the entire exhaust gas system at operating temperature, which saves energy overall.

Preferably, in such embodiments, the electrical heating device is controlled to generate heat if the result of the comparison for none of the at least two positions is an exceeding of the target temperature by the respective local temperature.

In particular, the fluid transport device is controlled to transport heat from the electrical heating device to the first or second position at the earliest at a time at which a temperature of the electrical heating device exceeds at least one of the local temperatures.

The target temperature is advantageously determined as a function of one or more operating parameters of the exhaust gas system. In particular, the one or more operating parameters of the exhaust gas system comprise a pollutant concentration in the exhaust gas system and/or a regeneration requirement of one or more of the at least one exhaust gas purification components and/or a current minimum operating temperature of the at least one exhaust gas purification components and/or an ambient temperature and/or a probable remaining duration of the operating phase in which the internal combustion engine is not operated. This means that the right temperature can be set to suit the current operating conditions. For example, the operating temperature of a particulate filter in normal operation can be lower than the operating temperature during regeneration of the particulate filter, when the temperature must be set so high that soot particles can be burned off.

To determine the target temperature, reference can also be made, for example, to the method from DE 10 2021 208 258, which discloses a method for determining a feature for characterizing the current ability of the catalyst converter system to convert pollutants. Local conversion capacities for sections or partial volumes of the catalyst converter are determined on the basis of local temperatures, and from this a global or total conversion capacity of the catalyst converter or the entire exhaust gas system (with several individual catalyst converters) is determined. Since the catalyst converters have a certain heat capacity, not all of the catalyst converter volume will enter the thermal operating window at the same time after the internal combustion engine is started. Instead, the exhaust gas system with the catalyst converters will heat up from the front to the rear in the direction of flow, gradually increasing the convertible catalyst converter volume over time. This allows the heating output of the heating disk to be adjusted particularly precisely to the actual requirement.

If it is necessary to use the electric heating device, the heating output required to heat both the heating disk itself and the supplied fluid flow can be calculated directly by inverting the underlying physical models. The dynamic shaping of the heating process can be realized by correspondingly varying the time constant depending on the deviation between the target and current temperature of the heating disk and, if necessary, the fluid mass flow (e.g., small time constant and correspondingly high output requirement with a large difference to the target temperature or high mass flow in order to dynamically promote heating). In particular, operating switchovers, for example for operation without or with transport air mass flow or engine stopped/running or cold start heating, temperature maintenance, particulate filter regeneration, etc. can thus be omitted and the functional control logic simplified accordingly.

A computing unit according to the invention, e.g., a control device of a motor vehicle, is configured, in particular in terms of programming, to carry out a method according to the invention.

The implementation of a method according to the invention in the form of a computer program or computer program product comprising program code for carrying out all method steps is advantageous as well, because the associated costs are very low, in particular if an executing control device is also used for other tasks and is therefore already available. Lastly, a machine-readable storage medium is provided, on which a computer program as described above is stored. Suitable storage media or data carriers for providing the computer program are in particular magnetic, optical and electrical memories, such as hard drives, flash memories, EEPROMs, DVDs, etc. Downloading a program via computer networks (Internet, intranet, etc.) is possible, too. Such a download can be wired or cabled or wireless (e.g., via a WLAN, a 3G, 4G, 5G, or 6G connection, etc.).

Further advantages and embodiments of the invention will emerge from the description and the accompanying drawing.

The invention is illustrated schematically in the drawing on the basis of an exemplary embodiment and is described in the following with reference to said drawing.

### BRIEF DESCRIPTION OF THE DRAWINGS

FIG. 1 shows an arrangement with an internal combustion engine and exhaust gas system, as the invention may be based on.

FIG. 2 shows a schematic embodiment of a method according to the invention in the form of a simplified flow chart.

### DETAILED DESCRIPTION

The following description explains an exemplary embodiment of the invention using an exhaust gas system of a gasoline engine with three-way catalyst converters (TWC) used there. However, it should be noted that the proposed method is also suitable for diesel or other internal combustion engines, e.g., gas or H₂ burners. Here, the respective burner-specific catalyst converters are used instead of the TWC, e.g., oxidation catalyst converter, SCR, particulate filter, NSC, etc.

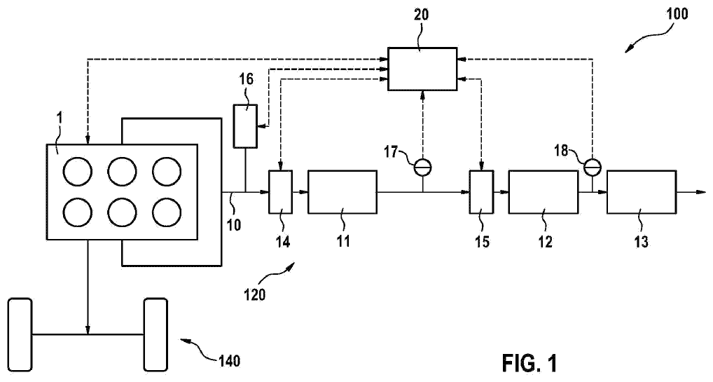

FIG. 1 schematically shows an arrangement with an exhaust gas system as can be used in the context of the invention, for example a vehicle, and is labeled 100.

The vehicle 100 comprises an internal combustion engine 1, which is used to drive wheels 140 of the vehicle 100, and an exhaust gas system 120 with a plurality of catalyst converters 11, 12, 13 arranged downstream of the internal combustion engine 1. In the example shown, sensors 17, 18 are arranged downstream of the catalyst converters 11, 12 and are each connected to a computing unit 20, for example a control device of the vehicle 100, in a data-conducting manner. The sensors can detect operating parameters of the exhaust gas system 120, for example temperatures, exhaust gas compositions, exhaust gas mass flows or the like. The positions of the sensors 17, 18 shown here are merely examples. Furthermore, the number of sensors is not limited to the two shown. In fact, more or fewer sensors can also be provided.

In the example shown, the computing unit 20 is also connected to the internal combustion engine 1 and external electrical heating devices 14, 15, which can each be assigned to one of the catalyst converters 11, 12, 13, and at least one fluid transport device 16, for example an air blower, in a data-conducting manner. In particular, the electrical heating devices 14, 15 can also be arranged directly in the catalyst converter or within a housing of the catalyst converter. It should be noted here that at least one electrical heating device 14, 15 and at least one fluid transport device 16 are required in the context of the present invention; however, several electrical heating devices, as shown in FIG. 1, and/or fluid transport devices 16 can also be used alongside one another and, for example, can each be controlled analogously to one another. In particular when using several heating devices 14, 15, each can be operated in such a way that it only takes into account the heating requirements of the components that are arranged directly downstream of it and upstream of the next heating device.

Exhaust gas 10 produced by the internal combustion engine 1 is fed to the catalyst converters 11, 12, 13 in a so-called normal operation of the internal combustion engine 1 in order to be purified or detoxified in these. Each of the catalyst converters 11, 12, 13 can be provided for a specific detoxification or for several simultaneous detoxifications. For example, a first catalyst converter 11, which can be arranged close to the internal combustion engine 1, can be designed as a three-way catalyst converter (TWC), while a second 12 and third 13 catalyst converter can comprise other catalyst converters and/or purification components such as NOx storage catalyst converters, SCR catalyst converters, particulate filters or the like. However, the second and third catalyst converters 12, 13 may also comprise one or more further TWCs. Furthermore, the first catalyst converter 11 can also comprise one or more other purification components and does not necessarily have to be designed as a TWC.

Depending on the respective catalyst converter type, each of the catalyst converters 11, 12, 13 has a specific thermal operating range, which is also referred to as the conversion window. For effective conversion, a predeterminable minimum temperature must be reached, also known as the light-off temperature. Above the light-off temperature, the respective pollutants are converted into less harmful substances. However, an increase in efficiency can be achieved if the respective catalyst converter is operated at a temperature that is higher than the light-off temperature. In such a case, a target temperature is advantageously specified for the respective catalyst converter 11, 12, 13. As explained at the beginning, control can generally also be based on the thermally active volume proportions of the purification components. However, the invention will be explained here using an example with temperature-based control.

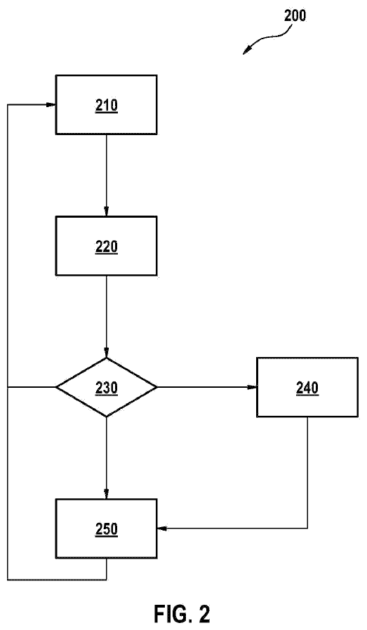

In FIG. 2, an advantageous embodiment of a method according to the invention is shown schematically in the form of a simplified flow chart and labeled 200. For the sake of simplicity, only the control of a single electrical heating device 14 and a single fluid transport device 16 is described here; if several heating devices and/or fluid transport devices are present, each can be operated in the same way as described here.

The method 200 uses temperatures of exhaust gas system 120, e.g., catalyst converter temperature(s), t_Cat, and possibly heating device, t_EHC, as input variables. These input variables can be determined on the basis of sensors and/or models. As in the example shown here, the method can also use other input variables in order to map the thermal behavior of the exhaust gas system as precisely as possible. For example, such additional input variables can comprise ambient temperature, humidity, and/or vehicle speed. These are particularly relevant parameters for determining the cooling effect of the air flowing around the exhaust gas system.

Based on the input variables, at least one temperature within the exhaust gas system 120 is determined as part of a step 210 of the method 200. This can be sensor-based or model-based. A combination of sensor-based and model-based determination is also possible.

In a step 220, a temperature distribution within the exhaust gas system 120 is determined based on the at least one temperature determined in step 210. In the simplest case, such a temperature distribution can describe local temperatures for two spaced-apart positions within the exhaust gas system. However, the temperature distribution can also describe several local temperatures or a continuum of local temperatures at respective positions.

For example, a physical model can be used for this purpose, which determines the at least two local temperatures or the temperature distribution based on the input variables or the at least one temperature within the exhaust gas system 120. In some embodiments, steps 210 and 220 may also be combined, in particular if the temperature determination is model-based.

In a step 230, the local temperatures are compared with a target temperature. In particular, the target temperature can be a light-off temperature of a catalyst converter in the exhaust gas system. In some embodiments, this light-off temperature can take into account the aging of the catalyst converter in question, since the light-off temperature typically increases as the catalyst converter ages.

Depending on the result of the comparison from step 230, there are various ways in which the method 200 continues:

If the comparison 230 in a first case shows that all determined local temperatures reach or exceed the target temperature, the method 200 returns to step 210.

In a second case, in which none of the local temperatures exceeds the target temperature and at least one of the local temperatures falls below the target temperature, the at least one fluid transport device 16 is controlled in a step 250 such that it transports heat from the at least one electrical heating device 14, 15 to the at least one position at which the corresponding local temperature falls below the target temperature. If the respective heating device 14, 15 has a temperature that is also below the target temperature, the corresponding heating device 14, 15 is first heated above the target temperature or at least above the lowest of the local temperatures (step 240) and then the fluid transport device 16 is controlled for heat transport in order to avoid further cooling of the exhaust gas system 120 by heat transport fluid at too low a temperature.

However, if in a third case the target temperature is exceeded at at least a first position within the exhaust gas system 120, while it is undershot at a second position, the use of the electrical heating device(s) 14, 15 can be dispensed with. In such a case, the at least one fluid transport device 16 is controlled to transport heat transfer fluid from the first position to the second position (step 250) to equalize the temperature so that the temperature at the second position approaches the target temperature again. If the excess heat at the first position is not sufficient to raise the local temperature at the second position above the target temperature, the electric heating device can be used to compensate for the heat deficit and controlled accordingly to generate the missing heat. Whether the excess heat at the first position is sufficient can be calculated on the basis of the known heat capacities and the determined local temperatures at the first and second positions.

It should be emphasized that the method 200 cannot normally be carried out with exhaust gas as the heat transfer fluid, but instead externally conveyed fluids, in particular air, are used. This is particularly advantageous in situations in which no exhaust gas mass flow is available, for example in situations in which the vehicle 100 is stationary and/or the internal combustion engine 1 is not being operated (e.g., before a departure, in start-stop mode, during an electrically powered journey in hybrid vehicles, etc.). The direction in which the fluid is conveyed for heat transfer depends on the temperature distribution within the exhaust gas system.

Method 200 was described here with a focus on keeping the catalyst converters warm in hybrid-electric operation. However, the method 200 can also be transferred to other areas, such as supporting particulate filter regeneration or NOx storage regeneration.

1. A method (200) for controlling heat transport within an exhaust gas system (120) downstream of an internal combustion engine (1), wherein the exhaust gas system (120) comprises at least one electrical heating device (14, 15), at least one exhaust gas purification component (11, 12, 13) and at least one fluid transport device (16), wherein the method (200) comprises in an operating phase in which the internal combustion engine (1) is not operated:
determining at least one current temperature (210) in the exhaust gas system (120), carrying out a comparison of the at least one determined current temperature or a temperature derived therefrom with a target temperature (230), and
controlling (240, 250) the electric heating device (14, 15) and/or the fluid transport device (16) depending on the result of the comparison (230).

2. The method (200) according to claim 1, wherein the determination of the current temperature in the exhaust gas system (210) is performed based on a temperature model of the exhaust gas system (120).

3. The method (200) according to claim 1, further comprising determining a temperature distribution (220) within the exhaust gas system (120) based on the at least one current temperature, wherein the temperature distribution describes respective local temperatures for at least two spaced apart positions in the exhaust gas system (120), wherein each of the local temperatures is used as a temperature derived from the at least one current temperature for the comparison.

4. The method (200) according to claim 3, wherein the fluid transport device (16) is controlled (250) such that fluid transported by it transports heat from a first one of the at least two positions to a second one of the at least two positions when the result of the comparison (230) is a falling below of the target temperature by the local temperature at the second position and at the same time an exceeding of the target temperature by the local temperature at the first position.

5. The method (200) according to claim 3, wherein the electric heating device (14, 15) for generating heat is controlled (240) when the result of the comparison (230) for none of the at least two positions is an exceeding of the target temperature by the respective local temperature.

6. The method (200) according to claim 5, wherein the fluid transportation device (16) is controlled (250) for transporting heat from the electric heating device (14, 15) to the first and second positions, respectively, at the earliest at a time when a temperature of the electric heating device (14, 15) exceeds at least one of the local temperatures.

7. The method (200) according to claim 1, wherein the target temperature is determined as a function of one or more operating parameters of the exhaust gas system (120) and/or the internal combustion engine (1).

8. The method (200) according to claim 7, wherein the one or more operating parameters are selected from a group consisting of a pollutant concentration in the exhaust gas system (120), a regeneration requirement of one or more of the at least one exhaust gas purification component (11, 12, 13), current minimum operating temperature of the at least one exhaust gas purification component (11, 12, 13), an ambient temperature, and an expected remaining duration of the operating phase in which the internal combustion engine (1) is not operated.

9. A computing unit (20) which is configured to perform all method steps of a method (200) according to claim 1.

10. A non-transitory, computer-readable storage medium containing instructions that when executed by a computer cause the computer to control a heat transport within an exhaust gas system (120) downstream of an internal combustion engine (1), wherein the exhaust gas system (120) comprises at least one electrical heating device (14, 15), at least one exhaust gas purification component (11, 12, 13) and at least one fluid transport device (16), wherein the internal combustion engine (1) includes an operating phase in which the internal combustion engine (1) is not operated, by:
determining at least one current temperature (210) in the exhaust gas system (120),
carrying out a comparison of the at least one determined current temperature or a temperature derived therefrom with a target temperature (230), and
controlling (240, 250) the electric heating device (14, 15) and/or the fluid transport device (16) depending on the result of the comparison (230).
